(19) United States
(12) Patent Application Publication
(10) Pub. No.: US 2025/0165863 A1
(43) Pub. Date: May 22, 2025

(54) SYSTEMS AND METHODS FOR MACHINE UNLEARNING

(71) Applicant: JPMORGAN CHASE BANK, N.A., New York, NY (US)

(72) Inventors: Jialei SHI, London (GB); Konstantinos GOURGOULIAS, London (GB); Sean MORAN, London (GB); Najah GHALYAN, Wayne, NJ (US); John BUFORD, Somerset, NJ (US); Leandro RIOS, Capital Federal (AR)

(21) Appl. No.: 18/947,994

(22) Filed: Nov. 14, 2024

(30) Foreign Application Priority Data
Nov. 16, 2023 (GR) 20230100952

(51) Int. Cl. G06N 20/00

(52) U.S. Cl. CPC G06N 20/00

(57) ABSTRACT

A method may include: receiving a set of retain samples comprising retain features to retain in a pretrained machine learning model, and a set of forget samples comprising forget features to remove from the pretrained machine learning model; providing the set of retain samples to the pretrained machine learning model resulting in a retain output and the set of forget samples to the pretrained machine learning model, resulting in a forget output; generating a set of retain weights and a set of forget weights based on the retain output and the forget output; freezing the set of retain weights; setting each forget weight to an initial state; executing a training epoch using the pretrained machine learning model and the retain samples that retrains the forget weights using the retain samples; combining the retrained forget weights with the retained weights to form an unlearned machine learning model.

### RELATED APPLICATIONS

This application claims priority to, and the benefit of, Greek patent application No. 20230100952, filed Nov. 16, 2023, the disclosure of which is hereby incorporated, by reference, in its entirety.

### BACKGROUND

### 1. Field of the Invention

Embodiments generally relate to systems and methods for machine unlearning.

### 2. Description of the Related Art

Machine learning models have achieved impressive results across many domains, but their continued deployment raises concerns around privacy, fairness, and model governance. Once a model has been trained on certain data, it can be challenging to fully “unlearn” that information. Models trained on problematic, biased, or private data may run afoul of governmental or corporate regulations. While collecting clean and ethical training data is ideal, it is not always feasible nor efficient to retrain models from scratch. Instead, methods to retroactively “unlearn” sensitive information from deployed models are needed. Existing machine unlearning algorithms face tradeoffs in computational efficiency, rigor, and interpretability. Lightweight, generalizable, and principled unlearning techniques amenable to real-world deployment remain scarce.

### SUMMARY OF THE INVENTION

Systems and methods for machine unlearning are disclosed. In one embodiment, a method may include: receiving, by a computer program executed by a computer processor, a set of retain samples comprising a plurality of retain features to retain in a pretrained machine learning model, and a set of forget samples comprising a plurality of forget features to remove from the pretrained machine learning model; providing, by the computer program, the set of retain samples to the pretrained machine learning model, wherein the pretrained machine learning model generates a retain output; providing, by the computer program, the set of forget samples to the pretrained machine learning model, wherein the pretrained machine learning model generates a forget output; generating, by the computer program and using an influence function, a set of retain weights and a set of forget weights based on the retain output and the forget output; freezing, by the computer program, the set of retain weights; setting, by the computer program, each forget weight to an initial state; executing, by the computer program, a training epoch using the pretrained machine learning model and the retain samples, wherein the training epoch retrains the forget weights using the retain samples; combining, by the computer program, the retrained forget weights with the retained weights to form an unlearned machine learning model; and deploying the unlearned machine learning model.

In one embodiment, the retain weights are identified as contributing to the retain output; and the forget weights are identified as contributing to the forget output.

In one embodiment, the influence function computes a computational efficient estimation using Stochastic Estimation, a Conjugate Gradient Method, Hessian-vector products, or a Fisher Information Matrix.

In one embodiment, a number of forget weights to be set to the initial state is based on a threshold hyperparameter.

In one embodiment, the threshold hyperparameter is selected based on a heuristic, a statistical metric, or a grid search.

In one embodiment, the threshold hyperparameter is selected to maximize or minimize a statistical measure between weight pairs.

In one embodiment, the statistical measure comprises a Kullback-Leibler divergence, a mean squared error, or a root mean squared error.

In one embodiment, the initial state comprises a value of 0.

In one embodiment, the initial state comprises a pretraining state for the pretrained machine learning model.

In one embodiment, the initial state comprises a normal distribution.

According to another embodiment, a non-transitory computer readable storage medium may include instructions stored thereon, which when read and executed by one or more computer processors, cause the one or more computer processors to perform steps comprising: receiving a set of retain samples comprising a plurality of retain features to retain in a pretrained machine learning model, and a set of forget samples comprising a plurality of forget features to remove from the pretrained machine learning model; providing the set of retain samples to the pretrained machine learning model, wherein the pretrained machine learning model generates a retain output; providing the set of forget samples to the pretrained machine learning model, wherein the pretrained machine learning model generates a forget output; generating, using an influence function, a set of retain weights and a set of forget weights based on the retain output and the forget output; freezing the set of retain weights; setting each forget weight to an initial state; executing a training epoch using the pretrained machine learning model and the retain samples, wherein the training epoch retrains the forget weights using the retain samples; combining the retrained forget weights with the retained weights to form an unlearned machine learning model; and deploying the unlearned machine learning model.

In one embodiment, the retain weights are identified as contributing to the retain output; and the forget weights are identified as contributing to the forget output.

In one embodiment, the influence function computes a computational efficient estimation using Stochastic Estimation, a Conjugate Gradient Method, Hessian-vector products, or a Fisher Information Matrix.

In one embodiment, a number of forget weights to be set to the initial state is based on a threshold hyperparameter.

In one embodiment, the threshold hyperparameter is selected based on a heuristic, a statistical metric, or a grid search.

In one embodiment, the threshold hyperparameter is selected to maximize or minimize a statistical measure between weight pairs.

In one embodiment, the statistical measure comprises a Kullback-Leibler divergence, a mean squared error, or a root mean squared error.

In one embodiment, the initial state comprises a value of 0.

In one embodiment, the initial state comprises a pretraining state for the pretrained machine learning model.

In one embodiment, the initial state comprises a normal distribution.

According to another embodiment, a method may include: generating a set of retain samples and a set of forget samples; passing the set of retain samples and the set of forget samples through a model, wherein the model generates output based on the set of retain samples and output based on the set of forget samples; processing the output based on the set of retain samples and the output based on the set of forget samples as input to an influence function, wherein the influence function generates a retain weights index and a forget weights index; freezing weights included in the retain weights index; setting weights included in the forget weights index to an initial state; executing a training epoch, wherein the training epoch retrains the weights included in the forget weights index based on the set of retain samples; and combing the retrained weights in the forget weights index with the weights in the retain weights index to form an unlearned model.

### BRIEF DESCRIPTION OF THE DRAWINGS

FIG. 1 depicts a system for machine unlearning according to an embodiment;

FIG. 2 depicts a method for a machine unlearning process according to an embodiment; and

FIG. 3 is a block diagram of a technology infrastructure and computing device for implementing certain aspects of the present disclosure, in accordance with aspects.

### DETAILED DESCRIPTION OF PREFERRED EMBODIMENTS

Embodiments generally relate to systems and methods for machine unlearning. In general, according to an embodiment, a process may identify parameters of a trained model that are most responsible for remembering the set to forget, and may freeze the weights for parameters other than those parameters. The weights for the parameters that are not frozen may be fine-tuned to reinforce the performance of the model.

The disclosure of Shi et al. “DeepClean: Machine Unlearning on the Cheap by Resetting Privacy Sensitive Weights using the Fisher Diagonal,” available at api.semanticscholar.org/CorpusID: 265281253 (2023), the disclosure of which is hereby incorporated, by reference, in its entirety.

Embodiments may selectively remove information from trained models to address these concerns without requiring full retraining. Embodiments may include a novel machine unlearning algorithm, which may advance the field by developing an efficient and interpretable unlearning method based on analyzing the diagonal Fisher Information Matrix across training subsets. This enables “forgetting” of sensitive information without requiring model retraining or access to an original full dataset used for initial training. Embodiments may further provide an optimization framework to identify a small subset of weights that, if reset, maximally reduces information related to sensitive information in the data while minimally impacting accuracy on other attributes of the task.

As used herein, the terms “machine unlearning” and “unlearning” refer processes and processing to remove the impact of certain samples from a trained model. An influence function is a method used to map weights' importance to individual samples. “Features” refer to labels of records used in training machine learning (ML) algorithms. “Weights” refer to trainable weights of neural networks. “Biases” refer to a trainable bias of neural networks. A “pretrained model” refers to a model that has been trained with a plurality of samples, including sensitive samples. “Fine-tuning” refers to a further training process of the pretrained model. “Forget samples” are samples whose impact will be removed from a pretrained model (e.g., using an unlearning process). “Retain samples” are samples whose impact will be retained with respect to a pretrained model. An “epoch” is an iteration of training with a machine learning algorithm, and epochs are a number of rounds of such training.

“Unlearning” has a similar or interchangeable meaning with the following terms: removing, scrubbing, wiping, forgetting, hiding, masking, destroying, scouring, depurating, eliminating, reverting, erasing, undoing, disregarding, negating, nullifying, expunging, extracting, withdrawing, dislodging, purging, extinguishing, abolishing, invalidating, annulling, repealing, rescinding, retracting, etc.

The process described herein may be used in several different scenarios with respect to various artificial intelligence (AI) services, such as client or regulator instructed records removal from an implementing organization's AI products, removal of different types of personal information (PI) (e.g., tabular data, unstructured data, free text, images, video, audio, etc.) from pretrained models, etc. Embodiments provide an unlearning process that negates the impact of any type or category of data in the above products.

In embodiments, records/samples that may be removed from the AI services may or may not share the same “features” (i.e., labels, categories, etc.).

Embodiments may provide a configurable way of identifying weights in a pre-trained model that need to be modified. For example, the weights may be identified through exact computation of second order derivatives guides (e.g., Hessian, Full Fisher Information Matrix, and other influence functions) that provide weight-importance mapping to records/samples. In some embodiments, the weights may be identified through approximation of second order derivatives guides.

Weights may also be identified through heuristics. In embodiments, all weights for certain layers may be modified, or only weights that satisfy certain conditions (e.g., weights with a value≥0.1) may be modified. Weights may be identified through combinations of heuristics, second order derivatives guides, and/or approximation of second order derivatives guides.

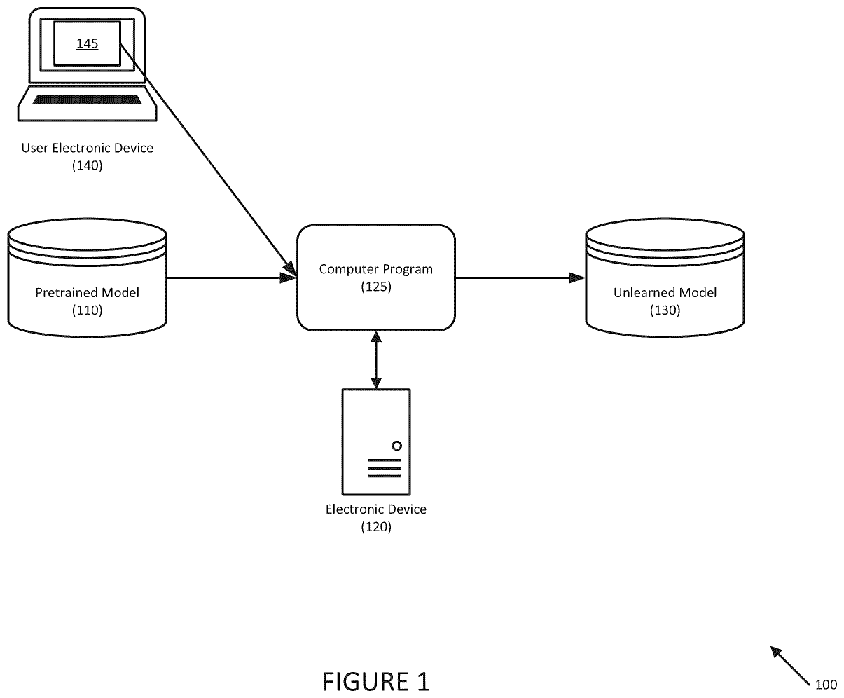

Referring to FIG. 1, a system for machine unlearning is provided according to an embodiment. System 100 may include pretrained model 110, which may be a machine learning model that is desired to be unlearned for certain attributes, electronic device 120 that may execute computer program 125 that may unlearn pretrained model 110, and unlearned model 130, which may be a version of pretrained model 110 that has been unlearned. Electronic device 120 may be a server (e.g., physical and/or cloud-based server), a computer (e.g., workstation, desktop, laptop, notebook, tablet, etc.), etc.

System 100 may further include user electronic device 140 that may execute user computer program 145. User electronic device may be a computer, a smart device (e.g., a smart phone, smart watch, etc.), etc. that may identify the attributes to be unlearned.

User electronic device 140 may provide a set of retain samples (e.g., samples that include retain features to retain in pretrained model 110), and a set of forget samples (e.g., samples that include forget features for pretrained model 110 to forget or to be removed from pretrained model 110). Pretrained model 110 may return a retain output and a forget output based on the forget samples and the retains samples, respectively.

Computer program 125 may receive the retain output and the forget output, and may compute an influence function using the retain output and the forget output.

The influence function may determine how the various samples input to the machine learning model contribute to the final output prediction of pretrained model 110 in terms of weights. Specifically, the influence function may determine which weights contribute to the output with respect to the forget samples and which weights contribute to the output with respect to the retain samples. For example, given a set of weights, the influence function may determine that a first subset of weights is associated with predictions based on the retain samples and a second subset of weights is associated with predictions based on the forget samples.

An exemplary influence function may include statistic-based calculations. For example, an influence function may compute a computational efficient estimation of some existing influence functions such as Stochastic Estimation, Conjugate Gradient Method, Hessian-vector products, Fisher Information Matrix, etc. An exemplary influence function may also or alternatively compute statistical estimations of the influence functions, i.e., instead of running the influence functions, estimate the results of influence functions directly.

The computer program may include customized heuristics which may be model agnostic. For instance, all early layers' weights may be frozen, the later layers' weights may be fine-tuned, all small value weights, may be frozen, only large value weights may be fine-tuned, a random percentage of weights may be frozen while the remaining weights are fine-tuned, etc.

In embodiments, the influence function may be model aware. Exemplary functions may freeze certain “kernels” in a CNN architecture; freeze specific attention matrix (e.g., query, key, or value) in a transformer architecture, and/or freeze all attention matrix for a given attention-head in a multi-head attention transformer.

In one embodiment, the influence function may combine the two approaches. For instance, a function may, after using the statistic calculation, further select the weights based on heuristics.

From the influence function, the computer program may output a set of retain weights that include weights determined to be associated with predictions based on the retain samples, and a forget weights that includes weights determined to be associated with predictions based on the forget samples.

An example is as follows. Suppose p (y|x, w) is the distribution of y, (e.g., a data point's class,) given parameters w ∈ Rₙ and x ∈ R_{d}. Then the empirical Fisher information matrix (FIM) of a dataset D given w is:

$${I}_{D} ( w ) = \frac{1}{\vert D \vert} {\sum }_{( y , x ) ∈ D} {∇}_{w} log p ( y \vert x , w ) {∇}_{w} log {p ( y \vert x , w )}^{T} .$$

The FIM may be used to identify the weights for the features in the forget samples, D_{f}. Given:

$$r ( {w}_{i} ) := \frac{{I}_{{D}_{f}} ( {w}_{i} )}{{I}_{{D}_{r}} ( {w}_{i} )} ,$$

where I_{D} (wᵢ): =(I_{D} (w))_{i, i}, the ith diagonal element of the empirical FIM. This ratio captures whether there is more information about wᵢ in D_{f} or the retain samples, Dᵣ.

Computer program 125 may then select a hyperparameter for threshold γ. Using threshold γ, the features that are most informed by D_{f} with the rule r(w)>γ may be selected, i.e., the sets Wᵣ={wᵢ: r(wᵢ)≤γ} and W_{f}={wᵢ: r(wᵢ)>γ} are produced.

Computer program 125 may then freeze all retain weights Wᵣ, and fine-tune the forget weights W_{f} on the retain samples, Dᵣ. This reduces the r(wᵢ) for all wᵢ ∈ W_{f} without requiring updating of the entire model, so the method is especially advantageous when 0<<|Wᵣ|.

The threshold hyperparameter γ may be used to decide how many weights should be updated. In an exemplary process, the selection of threshold hyperparameter γ may be done using heuristics, statistical/math metrics, Grid search, Meta-data guided selection, etc.

For instance, heuristics may identify a threshold that updates a certain percentage of all weights, a fixed threshold (e.g., 3), any other domain, data, model-specific metrics instructed, selection, etc., and or a generate and test method.

In one embodiment, a statistical/math metrics approach may identify a threshold hyperparameter γ that minimizes or maximizes a statistical measure (e.g., Kullback-Leibler (KL) divergence, mean squared error (MSE), root mean squared error (RMSE)) between forget-retain eight pairs; a threshold hyperparameter γ that minimizes or maximizes a statistical measure between model output distribution pairs; a threshold hyperparameter γ that minimizes or maximizes a customized metric that derived from applicable metrics, such as ratio/difference of distances, or ratio of matrices on top of either forget-retain weight pairs or output distribution pairs, etc.

A Grid search approach may iterate through as many threshold hyperparameters γ as possible, and may select the threshold hyperparameter γ that gives best unlearning performance. Metadata guided selection may use the meta information from the dataset, the pre-training stage, the intermediate training stage, previous applications of unlearning algorithm, previously unlearned models, etc. Examples of meta information for the dataset may include the characteristics and statistics of the datasets: size, distribution, number of samples, number of features, avg features per sample, etc. Examples of meta information for the pre-training stage may include information for the setup of the pretraining, like epochs, learning rate, etc. Examples of meta information for the intermediate training stage may include a gradient snapshot in the middle of the training, loss snapshots etc. Examples of meta information for the previously unlearned model or application may include hyperparameter selections from previous runs, further epoch training setup from previous runs, and experience that could guide a new unlearning.

Other meta information may be used as is necessary and/or desired.

In one embodiment, computer program 125 may execute one or more training epochs with respect to the weights in the set of forget weights. The training epochs may retrain the weights in the set of forget weights based on the values of the set of retain samples.

Computer program 125 may then combine the weights in the set of retain weights (which remain unchanged through all training epochs) with the weights from the set of forget weights that have been retrained to produce unlearned model 130 that has “forgotten” the impact of the original weight values in the set of forget weights.

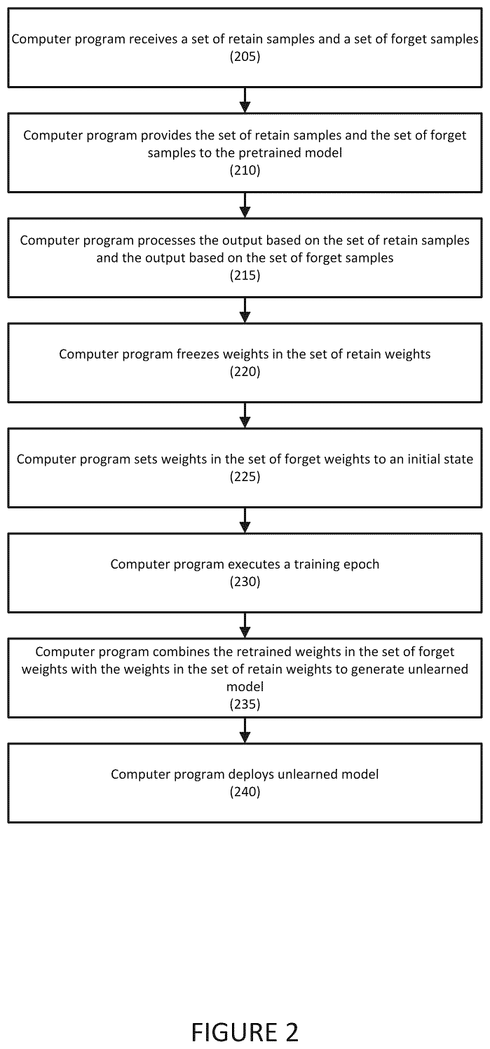

FIG. 2 depicts a method for machine unlearning according to an embodiment.

In step 205, a computer program may receive a set of retain samples and a set of forget samples for a pretrained model. The retain samples may include retain features to retain in a pretrained model, and the forget samples may include forget features for the pretrained model to forget or to be removed from the pretrained model.

In step 210, the computer program may provide the set of retain samples to the pretrained model, and may then provide the set of forget samples to the pretrained model. The pretrained model may generate a retain output and a forget output, such as weights, based on the set of retain samples and output based on the set of forget samples respectively.

In step 215, the computer program may process the outputs. In one embodiment, the computer program may provide the retain output and the forget output to an influence function that generates a set of retain weights and a set of forget weights. The set of retain weights may include the weights that the influence function determines are associated with predictions based on the retain samples, and the set of forget weights may include the weights that the influence function determines are associated with predictions based on the forget samples.

In step 220, the computer program may freeze the weights included in the set of retain weights, and in step 225, the computer program may set the weights for the features included in the set of forget weights to an initial state, such as “0” or to any other desired initial state, such as, e.g., normal distribution, uniform distribution, zeros and ones, etc. (i.e., an unaltered or pre-training state).

In step 230, the computer program may execute one or more training epochs that retrain the weights included in the set of forget weights using the set of retain samples. For example, the computer program may retrain the weights in the set of forget weights based on the values of the set of retain samples.

In step 235, the computer program may combine the retrained weights in the set of forget weights with the weights in the set of retain weights, resulting in an unlearned model. The unlearned model is a version of the pretrained model that has “forgotten” the impact of the original weight values in the set of forget weights.

In step 240, the computer program may deploy the unlearned model to a production environment.

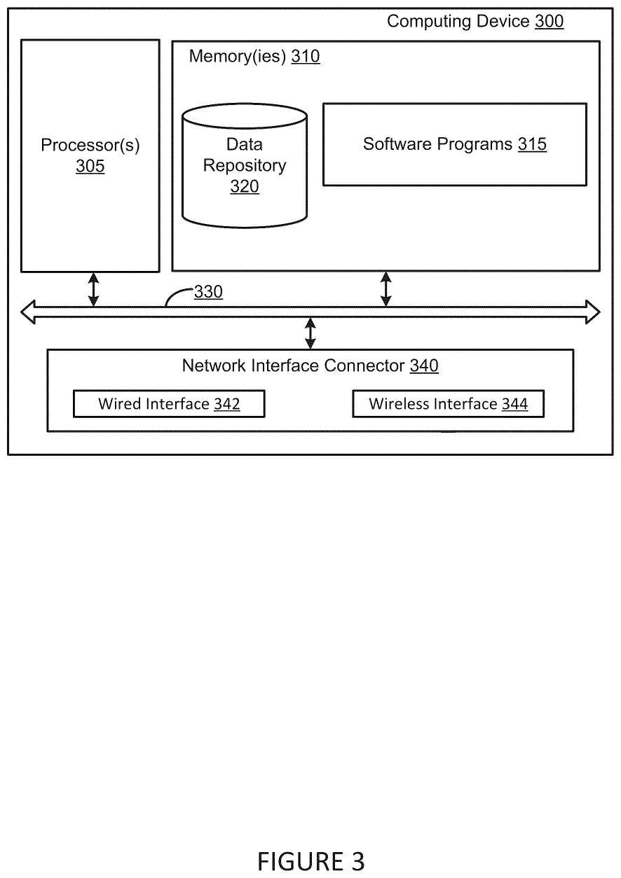

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method comprising:
receiving, by a computer program executed by a computer processor, a set of retain samples comprising a plurality of retain features to retain in a pretrained machine learning model, and a set of forget samples comprising a plurality of forget features to remove from the pretrained machine learning model;
providing, by the computer program, the set of retain samples to the pretrained machine learning model, wherein the pretrained machine learning model generates a retain output;
providing, by the computer program, the set of forget samples to the pretrained machine learning model, wherein the pretrained machine learning model generates a forget output;
generating, by the computer program and using an influence function, a set of retain weights and a set of forget weights based on the retain output and the forget output;
freezing, by the computer program, the set of retain weights;
setting, by the computer program, each forget weight to an initial state;
executing, by the computer program, a training epoch using the pretrained machine learning model and the retain samples, wherein the training epoch retrains the forget weights using the retain samples;
combining, by the computer program, the retrained forget weights with the retained weights to form an unlearned machine learning model; and
deploying the unlearned machine learning model.

2. The method of claim 1, wherein the retain weights are identified as contributing to the retain output; and the forget weights are identified as contributing to the forget output.

3. The method of claim 1, wherein the influence function computes a computational efficient estimation using Stochastic Estimation, a Conjugate Gradient Method, Hessian-vector products, or a Fisher Information Matrix.

4. The method of claim 1, wherein a number of forget weights to be set to the initial state is based on a threshold hyperparameter.

5. The method of claim 4, wherein the threshold hyperparameter is selected based on a heuristic, a statistical metric, or a grid search.

6. The method of claim 4, wherein the threshold hyperparameter is selected to maximize or minimize a statistical measure between weight pairs.

7. The method of claim 6, where the statistical measure comprises a Kullback-Leibler divergence, a mean squared error, or a root mean squared error.

8. The method of claim 1, wherein the initial state comprises a value of 0.

9. The method of claim 1, wherein the initial state comprises a pretraining state for the pretrained machine learning model.

10. The method of claim 1, wherein the initial state comprises a normal distribution.

11. A non-transitory computer readable storage medium, including instructions stored thereon, which when read and executed by one or more computer processors, cause the one or more computer processors to perform steps comprising:
receiving a set of retain samples comprising a plurality of retain features to retain in a pretrained machine learning model, and a set of forget samples comprising a plurality of forget features to remove from the pretrained machine learning model;
providing the set of retain samples to the pretrained machine learning model, wherein the pretrained machine learning model generates a retain output;
providing the set of forget samples to the pretrained machine learning model, wherein the pretrained machine learning model generates a forget output;
generating, using an influence function, a set of retain weights and a set of forget weights based on the retain output and the forget output;
freezing the set of retain weights;
setting each forget weight to an initial state;
executing a training epoch using the pretrained machine learning model and the retain samples, wherein the training epoch retrains the forget weights using the retain samples;
combining the retrained forget weights with the retained weights to form an unlearned machine learning model; and
deploying the unlearned machine learning model.

12. The non-transitory computer readable storage medium of claim 11, wherein the retain weights are identified as contributing to the retain output; and the forget weights are identified as contributing to the forget output.

13. The non-transitory computer readable storage medium of claim 11, wherein the influence function computes a computational efficient estimation using Stochastic Estimation, a Conjugate Gradient Method, Hessian-vector products, or a Fisher Information Matrix.

14. The non-transitory computer readable storage medium of claim 11, wherein a number of forget weights to be set to the initial state is based on a threshold hyperparameter.

15. The non-transitory computer readable storage medium of claim 14, wherein the threshold hyperparameter is selected based on a heuristic, a statistical metric, or a grid search.

16. The non-transitory computer readable storage medium of claim 14, wherein the threshold hyperparameter is selected to maximize or minimize a statistical measure between weight pairs.

17. The non-transitory computer readable storage medium of claim 16, where the statistical measure comprises a Kullback-Leibler divergence, a mean squared error, or a root mean squared error.

18. The non-transitory computer readable storage medium of claim 11, wherein the initial state comprises a value of 0.

19. The non-transitory computer readable storage medium of claim 11, wherein the initial state comprises a pretraining state for the pretrained machine learning model.

20. The non-transitory computer readable storage medium of claim 11, wherein the initial state comprises a normal distribution.
